(19) United States
(12) Patent Application Publication
(10) Pub. No.: US 2020/0128867 A1
(43) Pub. Date: Apr. 30, 2020

(54) Carrot drying and crushing integrated apparatus

(71) Applicant: Chunliang Mao, Ningbo City (CN)

(72) Inventor: Chunliang Mao, Ningbo City (CN)

(21) Appl. No.: 16/726,832

(22) Filed: Dec. 25, 2019

(30) Foreign Application Priority Data
Sep. 6, 2019 (CN) 2019108408952

(51) Int. Cl. A23N 12/08; B02C 18/14; B02C 23/10

(52) U.S. Cl. CPC A23N 12/083; B02C 23/10; B02C 18/142

(57) ABSTRACT

The invention discloses a carrot drying and crushing integrated apparatus, which includes a working box and a feeding port located in the working box, the feeding port is opened upward, and the working box is fixedly provided with the feeding box. A shattering cavity under the mouth, a shattering device is provided in the shattering cavity, and a stirring and drying cavity located under the shattering cavity is fixed in the working box, and the stirring and drying cavity is provided in the working box. There is a stirring and drying device. The working box is provided with a pulverizing cavity located below the stirring and drying cavity. The present invention simplifies the processing and drying of carrots by using an integrated device in one step. This step saves processing costs. For the problem that the inside of the carrot is difficult to dry and the drying degree is inconsistent, the device solves the above problems by cutting and drying, and grinds the carrot directly through the pulverizing device. It is powdered to realize the integration of carrot drying and crushing.

### CROSS-REFERENCES TO RELATED APPLICATIONS

The present application claims priority from Chinese application No. 2019108408952 filed on Sep. 6, 2019 which is hereby incorporated by reference in its entirety.

### FIELD OF TECHNOLOGY

The invention relates to the technical field of carrot powder processing, and in particular relates to a carrot drying and crushing integrated apparatus.

### TECHNICAL FIELD

With the development of society and the improvement of people's quality of life, there are more and more types of flour, and more and more types of raw materials are added to flour. Carrots are rich in sugars, fats, volatile oils, carotene, vitamin A, vitamin B1, Vitamin B2, anthocyanins, calcium, iron and other nutritional ingredients are often used in nutritional flour. In the production process, carrots are usually dried and pulverized. The existing devices usually separate and pulverize the carrots. In addition, a method of directly drying carrots is often used. Therefore, a carrot drying and pulverizing integrated device is urgently needed to solve the above problems. In view of the above disadvantages, the present invention makes improvements.

### CONTENT OF THE INVENTION

The technical problem to be solved by the present invention is to provide a carrot drying and pulverizing integrated device, which overcomes the above problems.

The present invention is achieved by the following technical solutions.

An integrated carrot drying and pulverizing device includes a work box and a feed port located in the work box, the feed port is opened upward, and a fixed position is fixed in the work box and is located below the feed port. A shattering cavity, a shattering device is provided in the shattering cavity, a stirring and drying cavity located under the shattering cavity is fixed in the working box, and a stirring and drying is provided in the stirring and drying cavity Device, the working box is provided with a crushing box located below the stirring and drying cavity, the crushing box is provided with a crushing cavity, a lower end of the crushing box is provided with a throw-out hole, and the throw-out hole is provided along the circumferential direction There are eight groups, a first rotating shaft is provided in the grinding chamber for rotation, the first rotating shaft extends outward to the outside of the grinding chamber, a first gear is fixed on the first rotating shaft, and the first rotating shaft A first pulverizer located in the pulverizing chamber is fixedly disposed on the right end surface of the pulverizing box, and a second rotating shaft is rotatably provided on the second rotating shaft. A second gear is fixed on the second rotating shaft. A first gear meshes, a third gear is fixed on the second rotating shaft, and the working box A rack is provided, and a fixed rod is fixed in the working box. The fixed rod is symmetrically arranged left and right. The rack is fixedly connected to the upper end of the fixed rod. The rack is engaged with the third gear. When carrots enter the shredding cavity through the feeding port, the shattering device starts to shred carrots, and the shredded carrots enter the stirring and drying cavity, and the stirring and drying device starts. The shredded carrots are dried, the dried carrots enter the crushing cavity, the crushing box rotates, and the first shredder is rotated to crush the dried carrots.

Further, the shattering device includes a motor located in the work box, a third rotation shaft is fixedly arranged on the right end face of the motor, the third rotation shaft extends to the right and is rotatably connected to the right end wall of the work box An active shattering tooth is fixed on the third rotating shaft, and an active gear is fixed on the third rotating shaft. The driving gear meshes with the fourth gear, and a fourth is fixed in the fourth gear. A rotating shaft, the fourth rotating shaft extends to the left and is rotatably connected to the left end wall of the work box. The fourth rotating shaft is fixedly provided with driving shattering teeth. When the carrot enters the smashing cavity, the motor is started to drive the third rotating shaft and the fourth rotating shaft to rotate and break the carrot.

Further, the stirring and drying device includes a fifth rotating shaft located in the working box, the fifth rotating shaft extends right into the stirring and drying chamber, and is connected to the right end of the stirring and drying chamber by rotation Wall, the fifth rotating shaft and the third rotating shaft are connected by a first pulley, the fifth rotating shaft is fixedly provided with a stirring plate located in the stirring and drying chamber, and the stirring plate is provided with three groups along the circumferential direction. A drying plate is fixed on the stirring plate, a first bevel gear is fixed on the fifth rotating shaft, the third rotating shaft rotates, and the fifth rotating shaft is driven by the first pulley to rotate the fifth rotating shaft. The rotation of the rotating shaft drives the stirring plate to rotate, and the drying plate starts to stir and dry the carrots in the stirring and drying chamber.

Further, a sleeve rod located at the lower side of the stirring and drying chamber is fixed in the working box, the sleeve rod is symmetrically arranged left and right, a sliding cavity is provided in the sleeve rod, and a fixed cavity is provided in the sliding cavity. In the electromagnet, a baffle is slidably arranged in the sliding cavity, the baffle extends outward to abut, a magnet is fixed on the upper end surface of the baffle, the magnet is symmetrically arranged up and down, and the electromagnet and the baffle are arranged symmetrically. Through the spring connection, when the carrots in the stirring and drying chamber are dried for a certain period of time, the electromagnet is energized, and the baffle is pulled to both sides to open the stirring and drying chamber.

Further, a filter is fixed in the work box, a vibration motor is fixed in the lower end surface of the filter, a collection chamber located under the vibration motor is fixed in the work box, and the vibration motor is started. Shaking the filter, so that the carrot powder on the filter falls into the collection cavity.

Further, a sixth rotating shaft located on the surface of the filter screen is rotatably provided in the work box, and a second bevel gear is fixed on the sixth rotating shaft, and the second bevel gear meshes with the first bevel gear. The working box is provided with a protection box located on the lower side of the crushing box. The working box is provided with a seventh rotating shaft located on the surface of the filter screen, and the seventh rotating shaft extends upward and is fixedly connected to the work box. The seventh end of the crushing box is connected with the sixth rotation shaft through the second pulley. The fifth rotation shaft rotates the sixth rotation shaft, and the sixth rotation shaft rotates the seventh shaft. The rotation shaft rotates, and the rotation of the seventh rotation shaft rotates the pulverization cavity, and the pulverized carrot is thrown out through the spit hole.

Further, a fifth gear is provided on the first rotating shaft, the fifth gear meshes with the sixth gear, an eighth rotating shaft is fixedly arranged in the sixth gear, and the eighth rotating shaft extends to the right Into the pulverizing cavity, and is rotatably connected to the right wall of the pulverizing cavity; a second pulverizer is fixed on the eighth rotating shaft; when the first rotating shaft rotates, the eighth rotating shaft is driven to rotate, so that The second pulverizer rotates to pulverize the carrot entering the pulverizing cavity.

Further, the protection box is provided with a discharge port, and the discharge port is symmetrically arranged back and forth. When carrots are thrown into the protection box, the carrots in the protection box can only pass through the discharge port. Was thrown out.

Further, when all the carrots in the stirring and drying chamber fall out, the electromagnet is powered off, and the baffle plate abuts under the action of the spring to reclose the stirring and drying chamber.

Beneficial effects of the present invention: The present invention completes the drying and crushing of carrots in one step with an integrated device, simplifies the steps of processing carrots, saves processing costs, addresses the problem of difficult drying inside carrots, and the degree of drying Inconsistent problems, the device solves the above problems by first chopping and then drying, and the carrot is directly pulverized into powder by the pulverizing device, thereby achieving the integration of carrot drying and pulverization.

### BRIEF DESCRIPTION OF THE DRAWINGS

The present invention is described in detail below with reference to FIGS. 1-4. For convenience of description, the orientation described below is defined as follows: the up-down, left-right, front-back direction described below is consistent with the up-down left-right, front-back direction of the projection relationship of FIG. 1.

FIG. 1 is a schematic diagram of an overall structure of a carrot drying and pulverizing integrated device according to the present invention;

FIG. 2 is a schematic structural diagram at A-A in FIG. 1;

FIG. 3 is a schematic structural diagram at B-B in FIG. 1;

FIG. 4 is a structural diagram at C-C in FIG. 1

### DETAILED DESCRIPTION OF THE INVENTION

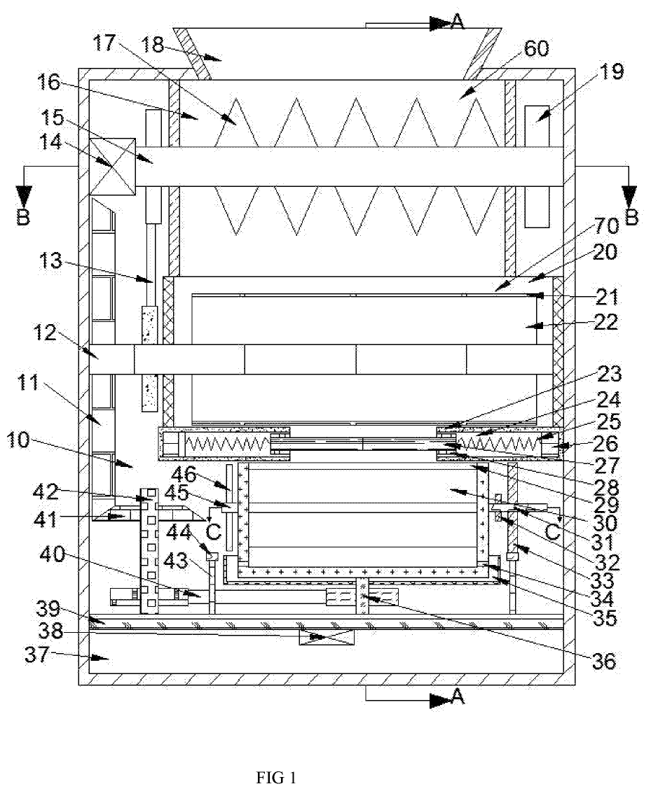

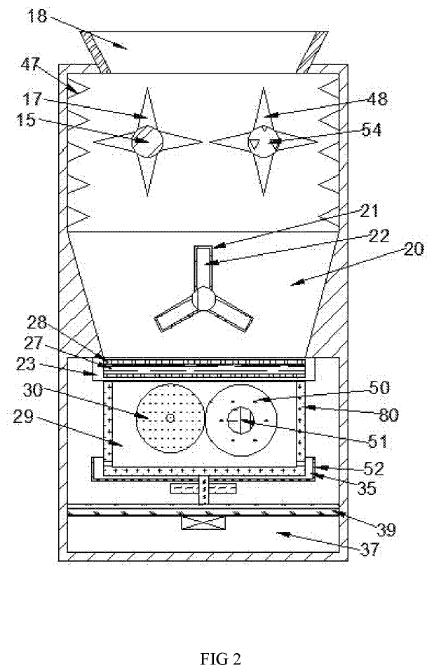

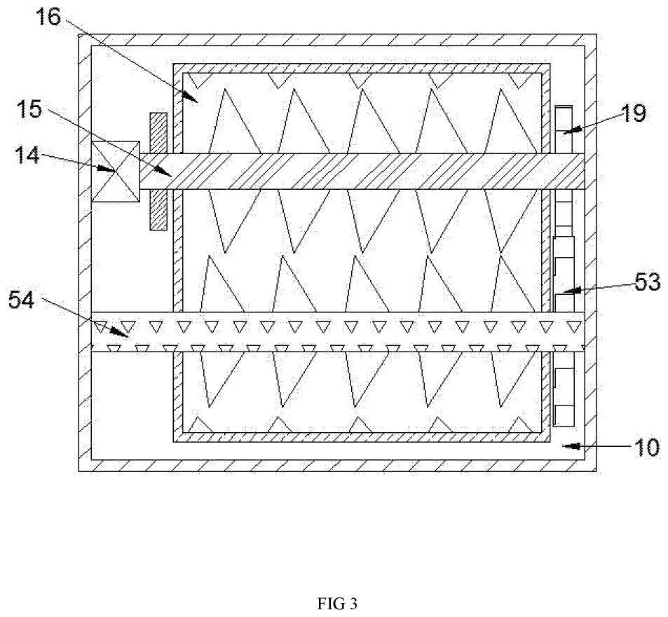

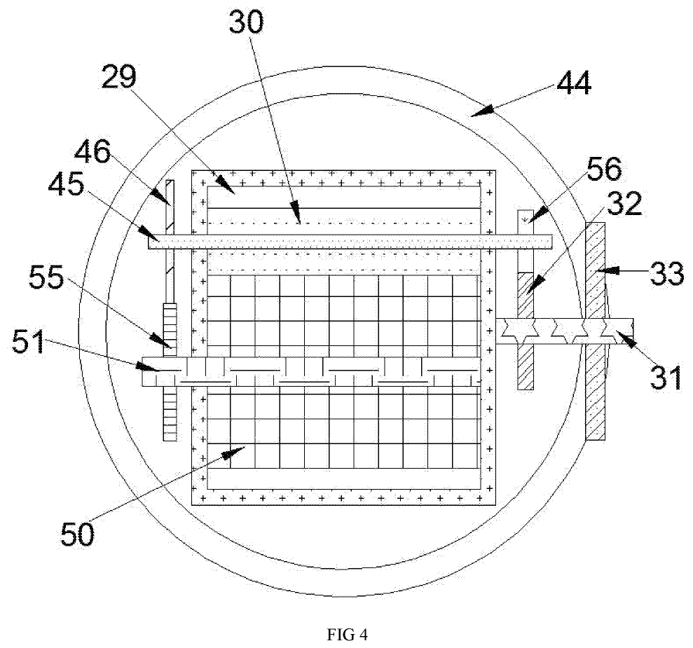

The present invention is described in detail below with reference to FIGS. 1-4, and for the sake of narration, the present invention will be further described with reference to the description of the drawings and embodiments. The manner of the present invention includes but is not limited to the following embodiments.

As shown in FIGS. 1-4, a carrot drying and pulverizing integrated device of the device of the present invention includes a working box 10 and a feeding port 18 located in the working box 10. The feeding port 18 is opened upward, so The work box 10 is fixedly provided with a shattering cavity 16 located below the feed port 18, the shattering cavity 16 is provided with a shattering device 60, and the work box 10 is fixedly provided with the shattering device 60. A stirring and drying chamber 20 below the crushing chamber 16, a stirring and drying device 70 is provided in the stirring and drying chamber 20, and a crushing box 80 is provided in the working box 10 and is located below the stirring and drying chamber 20 The crushing box 80 is provided with a crushing cavity 29. The lower end of the crushing box 80 is provided with a throw-out hole 34. The throw-out hole 34 is provided with eight groups in the circumferential direction. The crushing cavity 29 is provided with a first rotating shaft. 45. The first rotating shaft 45 extends outward to the outside of the pulverizing cavity 29. A first gear 56 is fixed on the first rotating shaft 45. The first rotating shaft 45 is fixed on the pulverizing cavity 29. In the first shredder 30, a right end surface of the shredder box 80 is rotatably provided with a second rotating shaft 31, and a second gear 32 is fixedly disposed on the second rotating shaft 31. The second gear 32 meshes with the first gear 56, a third gear 33 is fixed on the second rotating shaft 31, a rack 44 is provided in the work box 10, and a fixed is fixed in the work box 10. A rod 43, the fixed rod 43 is symmetrically arranged left and right, the rack 44 and the upper end surface of the fixed rod 43 are fixedly connected with the rack 44 and the third gear 33, and when the carrot passes through the feed port 18 When entering the shattering cavity 16, the shattering device 60 is started to shred carrots, and the shredded carrots enter the stirring and drying cavity 20, and the stirring and drying device 70 is started to shatter The dried carrots are dried, the dried carrots enter the crushing cavity 29, the crushing box 80 rotates, and the first crusher 30 is rotated to crush the dried carrots.

Beneficially, the shattering device 60 includes a motor 14 located in the work box 10, and a third rotation shaft 15 is fixed on the right end face of the motor 14, and the third rotation shaft 15 extends to the right and is rotatably connected to the The right end wall of the work box 10 is provided with an active shattering tooth 17 fixed on the third rotating shaft 15, and a driving gear 19 is fixed on the third rotating shaft 15, and the driving gear 19 meshes with the fourth gear 53. A fourth rotating shaft 54 is fixedly installed in the fourth gear 53, and the fourth rotating shaft 54 extends to the left and is rotatably connected to the left end wall of the work box 10. A transmission break is fixed on the fourth rotating shaft 54. Tooth 48, shattering teeth 47 are fixed on the front and rear walls of the shattering cavity 16, and when the carrot enters the shattering cavity 16, the motor 14 is started to drive the third rotating shaft 15, the first The four rotating shafts 54 rotate to break the carrot.

Beneficially, the stirring and drying device 70 includes a fifth rotating shaft 12 located in the working box 10, and the fifth rotating shaft 12 extends to the right into the stirring and drying chamber 20 and is connected to the stirring and rotating The right end wall of the drying chamber 20, the fifth rotating shaft 12 and the third rotating shaft 15 are connected by a first pulley 13, the fifth rotating shaft 12 is fixedly provided with a stirring plate 22 located in the stirring and drying chamber 20 The stirring plate 22 is provided with three groups along the circumferential direction. The drying plate 21 is fixed on the stirring plate 22. The first bevel gear 11 is fixed on the fifth rotating shaft 12. The third rotating shaft 15 rotates. The first pulley 13 drives the fifth rotating shaft 12 to rotate, and the fifth rotating shaft 12 rotates to rotate the stirring plate 22, and the drying plate 21 starts to stir and dry the stirring in the stirring and drying chamber 20 carrot.

Beneficially, a sleeve rod 23 located on the lower side of the stirring and drying chamber 20 is fixed in the work box 10, the sleeve rod 23 is symmetrically arranged left and right, and a sliding cavity 24 is provided in the sleeve rod 23. An electromagnet 26 is fixed in the sliding cavity 24, and a baffle plate 27 is slidably provided in the sliding cavity 24. The baffle plate 27 extends outward to abut, and a magnet 28 is fixed on the upper end surface of the baffle plate 27. 28 is arranged symmetrically up and down, and the electromagnet 26 and the baffle 27 are connected by a spring 25. When the carrots in the stirring and drying chamber 20 are dried for a certain period of time, the electromagnet 26 is energized and pulled to both sides The baffle 27 opens the stirring and drying chamber 20.

Beneficially, a filter screen 39 is fixed in the work box 10, a vibration motor 38 is fixed in the lower end face of the filter screen 39, and a collection chamber located under the vibration motor 38 is fixed in the work box 10. 37. The vibration motor 38 is started to vibrate the filter 39, so that the carrot powder on the filter 39 falls into the collection cavity 37.

Advantageously, a sixth rotating shaft 42 located on the upper surface of the filter screen 39 is rotatably provided in the work box 10, and a second bevel gear 41 is fixed on the sixth rotating shaft 42. The first bevel gear 11 is meshed, a protection box 35 is disposed in the work box 10 below the crushing box 80, and a seventh A rotating shaft 36, the seventh rotating shaft 36 extending upward and fixedly connected to the lower end surface of the crushing cavity 29, the seventh rotating shaft 36 and the sixth rotating shaft 42 are connected through the second pulley 40, and the fifth rotating shaft 12 rotation drives the sixth rotation shaft 42 to rotate, the sixth rotation shaft 42 rotates to drive the seventh rotation shaft 36 to rotate, and the seventh rotation shaft 36 rotates to drive the crushing box 80 to rotate, and the crushed carrot passes through the throw-out hole 34 is thrown out.

Beneficially, a fifth gear 46 is provided on the first rotating shaft 45, the fifth gear 46 is meshed with the sixth gear 55, and an eighth rotating shaft 51 is fixed in the sixth gear 55. Eight rotating shafts 51 extend right into the pulverizing cavity 29 and are connected to the right wall of the pulverizing cavity 29. A second pulverizer 50 is fixed on the eighth rotating shaft 51. When the first rotating shaft 45 rotates, Driving the eighth rotating shaft 51 to rotate, causing the second pulverizer 50 to rotate, and pulverizing the carrot entering the pulverizing cavity 29.

Beneficially, the protection box 35 is provided with a discharge port 52 which is symmetrically arranged front and rear. When carrots are thrown into the protection box 35, the carrots in the protection box 35 can only pass through. The discharge opening 52 is thrown out.

Beneficially, when all the carrots in the stirring and drying chamber 20 fall out, the electromagnet 26 is de-energized, and the baffle plate 27 abuts under the action of the spring 25 to reclose the stirring and drying chamber 20.

The sequence of mechanical actions of the entire device:

The initial state of the present invention is: the electromagnet 26 is not energized;

1. Put carrots into the feed opening 18;

2. Start the motor 14, the motor 14 starts to drive the third rotating shaft 15 to rotate, the third rotating shaft 15 rotates to drive the driving gear 19 to rotate, the driving gear 19 rotating to drive the fourth gear 53 to rotate, and the fourth gear 53 rotating to drive the fourth rotating shaft 54 to rotate, The shattering teeth 48 and the active shattering teeth 17 rotate and cut the carrot in the shattering cavity 16;

3. The third rotation shaft 15 rotates through the first pulley 13 to drive the fifth rotation shaft 12 to rotate, and the fifth rotation shaft 12 rotates to rotate the stirring plate 22, the drying plate 21 starts, and the carrots in the drying and drying chamber 20 are stirred and dried;

4. The electromagnet 26 is energized, attracts the magnet 28, pulls the baffle 27 to both sides, and opens the stirring and drying chamber 20;

5. When the fifth rotating shaft 12 rotates, the first bevel gear 11 is driven to rotate, and then the first bevel gear 11 is rotated to drive the second bevel gear 41 to rotate. The second bevel gear 41 is rotated to drive the sixth rotating shaft 42 to rotate. The sixth rotating shaft 42 and The seventh rotation shaft 36 is connected through the second pulley 40, the sixth rotation shaft 42 rotates to drive the seventh rotation shaft 36 to rotate, and the seventh rotation shaft 36 rotates to rotate the crushing box 80;

6. Because the third gear 33 and the rack 44 are in the meshing state, the rotation of the crushing box 80 drives the third gear 33 to rotate, and the rotation of the third gear 33 drives the second shaft 31 to rotate, and the second shaft 31 rotates to drive the second The gear 32 rotates, and the second gear 32 meshes with the first gear 56. The rotation of the second gear 32 drives the first gear 56 to rotate. The rotation of the first gear 56 drives the first shaft 45 to rotate, and the rotation of the first shaft 45 drives the fifth gear 46 to rotate. The fifth gear 46 meshes with the sixth gear 55. The rotation of the fifth gear 46 drives the sixth gear 55 to rotate, and the rotation of the sixth gear 55 drives the eighth rotation shaft 51 to rotate;

7. The eighth rotating shaft 51 and the first rotating shaft 45 are rotated to rotate the first pulverizer 30 and the second pulverizer 50 to pulverize the carrot;

8. The crushing box 80 is rotated to throw the carrot powder through the throw-out hole 34 and the discharge opening 52 onto the filter 39;

9. The vibration motor 38 is started, and the filter screen 39 is vibrated, so that the carrot powder on the filter screen 39 falls into the collection cavity 37.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A carrot drying and crushing integrated apparatus includes a working box and a feeding port located in the working box, the feeding port is opened upward, and is characterized in that the working box is fixedly provided with the feeding box. a shattering cavity under the mouth, a shattering device is provided in the shattering cavity, and a stirring and drying cavity located under the shattering cavity is fixed in the working box, and the stirring and drying cavity is provided in the working box. there is a stirring and drying device. the working box is provided with a crushing box located on the lower side of the stirring and drying chamber. the lower end of the crushing box is provided with a throw-out hole. the throw-out hole is provided with eight groups in the circumferential direction. a first rotating shaft is rotatably provided in the pulverizing cavity, the first rotating shaft extends outward to the outside of the pulverizing cavity, a first gear is fixed on the first rotating shaft, and a first gear is fixed on the first rotating shaft. the first pulverizer in the pulverizing chamber is provided with a second rotating shaft on the right end surface of the pulverizing box, and a second gear is fixed on the second rotating shaft, and the second gear meshes with the first gear. a third gear is fixed on the second rotating shaft, and a rack is provided in the working box. a fixed rod is fixedly arranged in the working box, the fixed rod is symmetrically arranged left and right, the rack and the upper end of the fixed rod are fixedly connected, the rack is engaged with the third gear, and when the carrot passes the feed when the mouth enters the shattering cavity, the shattering device starts to shred carrots, and the shredded carrots enter the stirring and drying cavity, and the stirring and drying device starts to shred the carrots. the dried and dried carrots enter the pulverizing cavity, and the pulverizing box rotates to drive the first pulverizer to rotate to pulverize the dried carrots.

2. The carrot drying and crushing integrated apparatus according to claim 1, wherein the shattering device comprises a motor located in the work box, and a third rotation shaft is fixed on the right end surface of the motor. The third rotation axis extends to the right and is rotatably connected to the right end wall of the working box. The third rotation axis is fixed with an active shattering tooth. The third rotation axis is fixed with an active gear. The active gear and The fourth gear meshes, a fourth rotating shaft is fixedly arranged in the fourth gear, the fourth rotating shaft extends to the left, is rotatably connected to the left end wall of the work box, and a transmission is fixed on the fourth rotating shaft. Shattering teeth. Shattering teeth are fixed on the front and rear walls of the shattering cavity. When carrots enter the shattering cavity, the motor is started to drive the third and fourth rotating shafts to rotate and beat.

3. The carrot drying and crushing integrated apparatus according to claim 1, wherein the stirring and drying device comprises a fifth rotating shaft located in the work box, and the fifth rotating shaft extends right to The stirring and drying chamber is rotatably connected to the right end wall of the stirring and drying chamber, the fifth rotating shaft and the third rotating shaft are connected by a first pulley, and the fifth rotating shaft is fixedly provided with the stirring shaft. There are three groups of stirring plates in the drying cavity. The stirring plates are provided with three groups along the circumferential direction. The drying plates are fixedly provided with the drying plates. The fifth rotating shaft is fixedly provided with a first bevel gear. The third rotating shaft rotates. The first belt wheel drives the fifth rotating shaft to rotate, and the fifth rotating shaft rotates to rotate the stirring plate, the drying plate is started, and the carrots in the stirring and drying chamber are stirred and dried.

4. The carrot drying and crushing integrated apparatus according to claim 1, characterized in that: a sleeve rod located at the lower side of the stirring and drying chamber is fixed in the working box, and the sleeve rod is symmetrically arranged left and right, A sliding cavity is provided in the sleeve rod, an electromagnet is fixed in the sliding cavity, a baffle is slid in the sliding cavity, the baffle extends outward to abut, and an upper end surface of the baffle is fixedly provided. The magnet is symmetrically arranged up and down, and the electromagnet and the baffle are connected by a spring. When the carrot in the stirring and drying chamber is dried for a certain period of time, the electromagnet is energized and pulls the baffle opens the stirring and drying chamber.

5. The carrot drying and crushing integrated apparatus according to claim 1, characterized in that: a filter is fixed in the work box, a vibration motor is fixed in the lower end of the filter, and the work box is fixed in the work box. A collecting cavity is provided on the lower side of the vibration motor, and the vibration motor is activated to vibrate the filter screen, so that the carrot powder on the filter screen falls into the collection chamber.

6. The carrot drying and crushing integrated apparatus according to claim 1, characterized in that: a sixth rotating shaft located on the surface of the filter screen is rotatably provided in the working box, and a sixth rotating shaft is fixedly provided on the sixth rotating shaft A two-bevel gear, the second bevel gear meshing with the first bevel gear, a protection box located on the lower side of the crushing box is provided in the work box, and a rotation filter provided on the filter net is provided in the work box A seventh rotating shaft on the surface, the seventh rotating shaft extending upward and fixedly connected to the lower end surface of the crushing box, the seventh rotating shaft and the sixth rotating shaft are connected through the second pulley, and the fifth rotating shaft is driven to rotate The sixth rotating shaft rotates, the sixth rotating shaft rotates to drive the seventh rotating shaft, and the seventh rotating shaft rotates to rotate the pulverizing box, and the pulverized carrot is thrown out through the throw-out hole.

7. The carrot drying and crushing integrated apparatus according to claim 6, wherein a fifth gear is provided on the first rotating shaft, the fifth gear meshes with the sixth gear, and the sixth An eighth rotating shaft is fixed in the gear, and the eighth rotating shaft extends right into the crushing cavity and is connected to the right wall of the crushing cavity. A second crusher is fixed on the eighth rotating shaft. When the first rotating shaft rotates, the eighth rotating shaft is driven to rotate, so that the second pulverizer is rotated to pulverize the carrot entering the pulverizing cavity.

8. The carrot drying and crushing integrated apparatus according to claim 6, characterized in that: the protection box is provided with a discharge port, and the discharge port is symmetrically arranged back and forth, when the carrot is thrown into the protection box During the middle period, the carrots in the protection box can only be thrown out through the discharge port.

9. The carrot drying and crushing integrated apparatus according to claim 3, characterized in that when all the carrots in the stirring and drying cavity fall out, the electromagnet is powered off, and the baffle is in the spring Under the action of the two, the stirring and drying chamber is re-closed.
